(19) United States
(12) Patent Application Publication
(10) Pub. No.: US 2011/0061139 A1
(43) Pub. Date: Mar. 10, 2011

(54) METHOD TO MEASURE 3 COMPONENT OF THE MAGNETIC FIELD VECTOR AT NANOMETER RESOLUTION USING SCANNING HALL PROBE MICROSCOPY

(76) Inventors: Ahmet Oral, Oxford (GB); Munir Dede, Ankara (TR); Rizwan Arkam, Topi (PK)

(21) Appl. No.: 12/554,825

(22) Filed: Sep. 4, 2009

(51) Int. Cl. G01N 13/10; G12B 21/00

(52) U.S. Cl. 850/1; 850/52

(57) ABSTRACT

Scanning hall probe microscopy is used to measure 3 components of the magnetic field vector at nanometer resolution by connecting of Hall probe to the end of the piezo scanner, then gluing of the sample to the sample holder, thereafter positioning of the SHPM head under the optical microscope with approximately ×40 magnification, then moving back of the slider puck around approximately 30 steps or moving the sensor or sample back by sufficient amount using motors, piezo or other positioner such that signal decays to negligible levels; thereafter setting the temperature of cryostat or to desired temperature, then offset nulling of the Hall sensor in gradiometer or normal conditions, and finally setting of the scan area, speed, resolution and the acquisition channels through SPM control program.

### BACKGROUND OF THE INVENTION

1. Field of the Invention

This invention relates to a method to measure 3 component of the magnetic field vector at nanometer resolution using scanning hall probe microscopy.

2. Description of the Related Art

The history of the Scanning Probe Microscopes (SPMs) started with the invention of Scanning Tunneling Microscope (STM) in 1981 by Binnig and Rohrer. In this technique an atomically sharp conductive tip is brought in to close proximity of a conductive sample. Classically electrons are not expected to overcome the potential barrier. But it is known, from quantum mechanics, that there exist a non zero possibility for electrons to tunnel the air or vacuum gap between the tip and the sample. The tunneling current is exponential function of the height of the tip over the sample. Thus, if the current is fed into a control circuit it is possible to control the height of the tip. By this way a sample surface could be scanned with atomic resolution. Shortly after the invention of STM, a new method, the Atomic Force Microscope (AFM), utilizing force interactions between tip and sample, has been invented. In AFM the conductive tip is replaced by a non-conductive tip attached to the end of a cantilever. The AFM is sensitive to the forces between the tip and the sample, which deflects the cantilever and is measured through an optical system. After AFM many different methods developed to examine different properties through various tip-surface interactions.

Probing techniques have also found applications in magnetism studies. Although it is possible to get information about the magnetic properties of the materials with macroscopic measurements, it is only possible to interpret them further with the aid of local measurement techniques done at the macroscopic level. Especially, the measurements performed on magnetic domains on the local scale helps to link the basic physical properties and the practical applications. The analysis of magnetization curve of a material, for example, requires a basic understanding of the domain structure, which is microscopic regions of identical magnetization direction, of that material. Magnetic imaging techniques allow the most direct visualization of magnetic properties on a microscopic scale and material properties can be studied.

Different classifications can be done for the magnetic imaging techniques considering the way in which depth sensitivity is achieved; the way in which the lateral information is acquired and the physical interaction with the sample magnetization. The first sensitivity is a measure of how deep the surface penetrated, and the information extracted from that depth, by the technique used. In other words it represents the probing depth. The way in which the lateral information is acquired, on the other hand, is relevant whether the sample surface is scanned or directly imaged. Classification with respect to the physical interaction includes the physical phenomenon which lies behind the measurement.

The scanning quantum interference device, SQUID, microscope for example, measures magnetic flux, the Hall probe measures magnetic stray field, and the magnetic force microscope (MFM) measures the gradient of the magnetic field convolved with the magnetic moment of the cantilever tip. In a Hall sensor the force on the electrons due to the stray field of the sample causes the electrons to accumulate and generate an electric field in the sensor and thus Hall voltage across the terminals of the Hall device. This is the physical interaction in Scanning Hall Probe Microscopy (SHPM).

The first realization of the Scanning Hall Probe Microscopy (SHPM) at sub-micron scale is given by Chang et al. in 1992. Since then the methods are spreading among the science community and already commercialized.

Scanning Hall Probe Microscope SHPM is a member of the Scanning Probe Microscopy (SPM) family and shares the common characteristics of these instruments. Although different subfield classifications are possible with respect to the interaction used or property measured, SPM in general, refers to techniques that use the interaction of a probe (or sensor) with the surface of a sample to measure various characteristics; surface topography, surface conductivity, static charge distribution, localized friction, magnetic fields, elastic moduli etc, of the sample at nanometer scale, in some cases atomic resolution. Thus, whatever the technique is used or property is inspected, there are a set of common elements used in all the SPMs.

In the original configuration proposed by Edwin Hall, the Hall sensors usually, has the form of plate, on the surface of the chip, fitted with four contacts. By the methods of integrated circuit technology, such a plate can merged into the chip surface, which is named as the “horizontal” configuration in which the Hall device is only sensitive to the magnetic field perpendicular to the chip plane. In the simplest case there exist, a square plate of n-well in a p-type doped semiconductor. When a current is passed through the contact on the dedicated pair of the n-well, consequential voltage is built up due to the perpendicular component of the applied magnetic field. This voltage is measured through the other pair of contacts. Some applications, on the other hand, may require, simultaneous measurement of the all three vector components Bₓ, B_{y} and B_{z} of the magnetic field B with a high spatial resolution on the specimen. The first novel device employing the Hall probes for the parallel field detection has suggested by R. S. Popovic. The motivation was to introduce a sensor capable of measuring the magnetic fields parallel to the chip surface, produced by the standard integrated circuit fabrication methods. The difficulty about the integration was the placement of the ohmic contacts for each pad forming the Hall element. To solve this, a Hall plate with the current carrying axis placed vertical to the chip plane is fabricated. In this configuration, due to the placement, the device is named as “vertical Hall effect device”. The device geometry is designed such that all the contacts become available at the top surface of the chip. The substrate, or the device, layer, is an n-doped silicon wafer surrounded by a p-doped region to isolate the sensor element. The contacts are ion implemented regions with higher doping concentrations with respect to the substrate. Note that this device is still one dimensional (1D) as the only measurable component of the magnetic field is the one perpendicular to the bias current. By putting together two such devices, the two-dimensional sensor (2D) is obtainable. In the cross-shaped device the four output current electrodes are connected together.

The voltage differences between the sensing contacts of each branch are directly proportional to the corresponding magnetic field components in two different directions. With such a sensor, it is now possible to measure the magnitude of a magnetic field in the X-Y plane. It is also possible to place these devices in an array, having more than two sensing elements for each direction or in different angular orientation. The operation principle and the sensitivity of the device is essentially unaffected by this unusual geometry. The 1D Hall device is similar to the JFET transistor, and the effective device thickness can be altered by applying negative voltage to the p-doped isolation ring.

Following to the same idea, one horizontal and one 2D vertical Hall elements can be placed together to obtain a 3D version, which can detect all three spatial components of the external magnetic field. Different orientation and positions are possible for the Hall sensors due to flexibility of the production method employed. To combine the elements in order to have a 3D sensor, two different approaches have been reported. The first approach is to place unidirectional (1D) individual elements in a perpendicular manner to each other. This is called “hybrid micro system”. Since the assembling the parts is difficult, alignment and angle errors may arise. Also, due to the huge measurement volume, local measurements are difficult and some corrections have to be applied to the acquired data. It should be noted that the term “hybrid” should not be confused with the applications where a Hall probe and readout integrated circuit (IC) are brought together on a single chip.

The other possibility consists of a one-chip micro system where various sensitive parts are integrated on a single substrate. These kinds of combinations have been demonstrated in the recent years in a number of studies. The main problem with this layout, reported by different groups, is the cross coupling between XYZ channels. The cross coupling (CC) is a parasitic effect observed in a channel when the external magnetic fields are applied in the other two perpendicular directions. Possible sources of it are the geometrical miss-alignments during the fabrication, temperature gradients, and different magnetoresistance behavior of the material in different directions. In other words, its occurrence is related to all of the physical phenomena that create a distribution irregularity in current or potential in the active region of the device. To reduce this effect, various tricks can be applied; simultaneous measurement of magnetic field vector by separation of the outputs, amperometric mode of operation, and calibration of CC. Another important criterion is the spatial resolution of the 3D probe systems. The reported spatial resolutions are of the order 100 μm or higher. The smallest reported size is 50 μm.

The papers below summarise a set of Hall sensors, where 3 or more hall sensors positioned on truncated pyramid faces are used to reconstruct magnetic field vector in ˜40 micrometer resolution. The Hall sensors are physically separated by each other ˜20-40 micrometer. This combined hall sensor is scanned across the sample surface to extract 3 components of the magnetic field vector on the surface:
a. D. Gregusova et al., Fabrication of a vector Hall sensor for magnetic microscopy, Applied Physics Letters, vol. 82, pp. 3704-3706, 2003.
b. D. Gregusova et al., Technology and properties of a vector hall sensor, Microelectronics Journal, vol. 37, pp. 1543-1546, 2006.
c. V. Cambel et al., Scanning vector Hall probe microscopy, Journal of Magnetism and Magnetic Materials, vol. 272-76, pp. 2141-2143, 2004.
d. J. Fedor et al., Scanning vector Hall probe microscope, Review of Scientific Instruments, vol. 74, pp. 5105-5110, 2003.

Another work by Amanda Petford-Long & her student presented at Magnetism and Magnetic Materials (MMM) or Intermag conference:
A transmission electron microscope is used to reconstruct the 3 components of the magnetic flux density in thin, electron transparent specimen. The electron beam is deflected due to in-plane magnetic field component as it traverses the specimen. The specimen is then rotated in two axis ˜3600 degrees and sequence of transmitted electron intensity images is obtained. These data are processed to reconstruct the magnetic field vector in and around the specimen.

S. Nomizu et al. ‘Reconstruction of Magnetic Fields by Reflection Electron Beam Tomography’, IEEE Trans. Magnetics 32(5), 4926 (1996) & references therein: where an electron beam is reflected by the magnetic field of the surface. The reflected electron profile is measured and the magnetic field vector on surface in 3D is reconstructed using this data.

### SUMMARY OF THE INVENTION

The invention presented here has the purpose of solving the known problems mentioned by implementing just one single magnetic sensor which measures only one component of the magnetic field.

It is an advantage of the invention that the sample to be imaged does not require any special sample preparation.

It is a further advantage of the invention is that the spatial resolution is defined by the spatial resolution of the single sensor used and is improved considerably compared to other existing prior methods.

It is a further advantage of the invention is that 3 component of the magnetic field vector at nanometer resolution measuring method needs limited amount of data analysis.

It is a further advantage of the invention is that 3 component of the magnetic field vector at nanometer resolution measuring method is much faster.

It is a further advantage of the invention is that 3 component of the magnetic field vector at nanometer resolution measuring method and scanning hall probe microscopy can be applied in variable temperature environments in external magnetic field.

In Scanning Hall Probe Microscopy, a Hall probe integrated with an STM tip is brought in to close proximity of the sample under inspection using the course approach mechanism. The sample is tilted 1-2° about the probe to have the STM tip at the highest position. Integrated STM tip keeps track of the surface just like in the case of STM seeking a tunneling current. The tunneling current is fed into a control electronic to maintain a constant current changing the height of the sensor with respect to the topography of the sample using a piezo tube scanner. This simultaneous topography and magnetic imaging can be accomplished while scanning the designated area within the scan range of the piezo. Overall control of approach and scan is maintained via dedicated SHPM control electronics. It is also possible to use AFM feedback which makes it possible to scan non-conductive samples for simultaneous topography and magnetic data. The technique can give quantitative data with high spatial resolution. Microscope can work in a wide temperature range under high magnetic fields.

### BRIEF DESCRIPTION OF THE DRAWINGS

FIG. 1. is a schematic layout of the Scanning Hall Probe Microscope

FIG. 2. is a detailed view of microscope body

FIG. 3. shows the orientation of hall sensor over the sample with respect to the scan directions

FIG. 4. shows the Hall effect with non-perpendicular current and voltage leads with different configurations under uniform magnetic field

FIG. 5. shows the Hall effect with non-perpendicular current and voltage leads with different configurations under non-uniform magnetic field

FIG. 6. shows the visualization of incremental scan for B_{z}(x,y,z), ∂B_{z}(x,y,z)/∂x and ∂B_{z}(x,y,z)/∂y

FIG. 7. shows the image of Hard disk in closest proximity and while the probe is lifted off by 3.5 μm

FIG. 8. shows the gradiometer images of Hard disk sample at various lift-offs

FIG. 9. shows the B_{z} field measured on the harddisk sample using SHPM.

FIG. 10. shows that B_{y} field calculated by integrating ∂B_{z}/∂y over a finite range.

FIG. 11. shows that Bₓ field calculated by integrating ∂B_{z}/∂x over a finite range

FIG. 12. shows magnetic bead detection using novel Hall gradiometer configuration

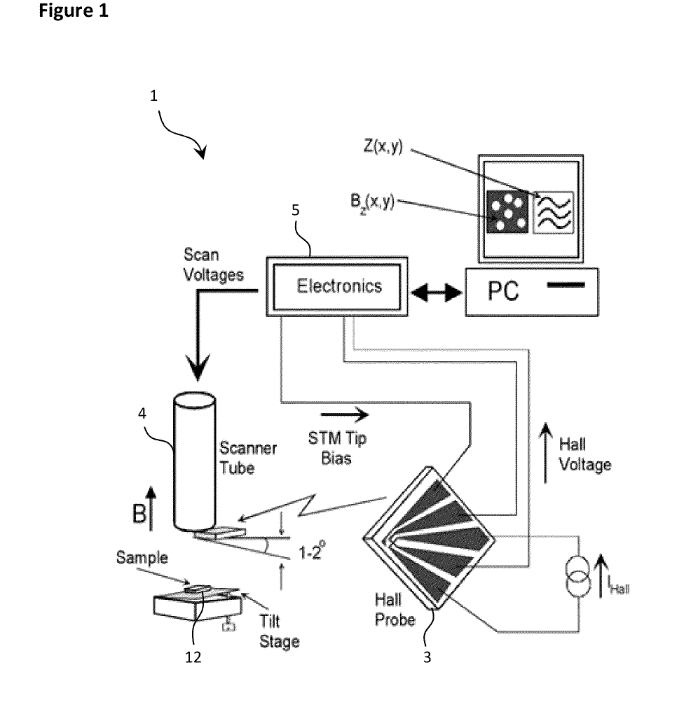

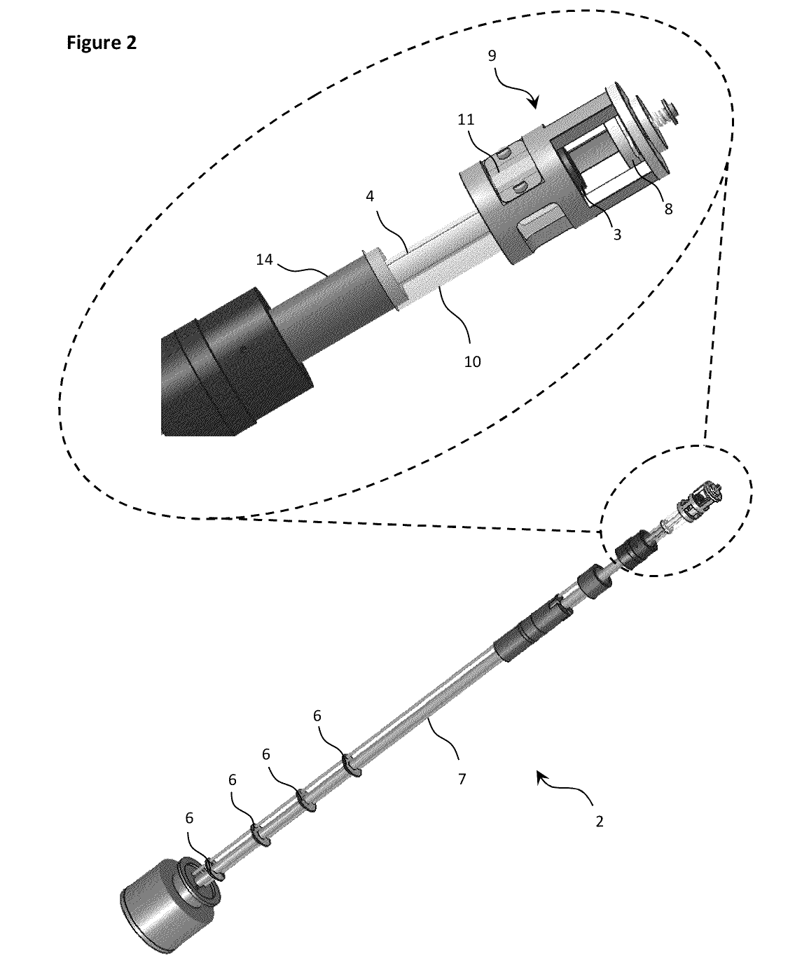

### DETAILED DESCRIPTION OF THE PREFERRED EMBODIMENTS

The scanning hall probe microscope (SHPM) (1) includes; a microscope body (2), a hall probe (3), an approach mechanism, a scanner (4) and control electronics (5). The microscope body (2) is an assembly housing all the mechanical parts, moving or stationary, which forms the microscope (1). The microscope body (2) preferably has a compact form in order to fit in to cryostat systems for low temperature applications. Moreover it includes radiation baffles (6), extension tube (7), sample holder (8), slider puck (9), slider tube (10), leaf spring (11) and hollow cylindrical shield. Radiation baffles (6) decrease the effect of the radiation from high temperature and help preserve the cryogen. The extension tube (7) is designed to bring the scanner head to the magnet center of the cryostat. It also houses the cables used for carrying signals. The sample (12) is placed on the sample holder (8) facing towards the sensor, which is mechanically attached to the slider puck (9). The puck (9) is then engaged over the slider tube (10) by properly tightened the leaf spring (11). The puck (9), which is held by static friction, is free to move along the slider tube (10). The hollow cylindrical shield is placed around the whole head to mechanically protect the scanner (4), to help maintaining the temperature stability and it shields the system from the electromagnetic noise.

The probe (3) is specially fabricated to be sensitive to a specific property aimed for measurement and interfaces the sample (12) with the rest of the microscope (1). The probe (3) in this invention is preferably a Hall sensor, which is sensitive to the perpendicular component of the stray magnetic field on the surface of the magnetic or the superconducting samples.

In another embodiment of the invention instead of using a Hall sensor, scanning superconducting quantum interference device (SQUID), tunneling magnetoresistance (TMR), giant magnetoresistance (GMR) can be used as a probe (3) to measure the magnetic field.

The Hall sensors are mounted on a non magnetic printed circuit board (PCB) that has suitable electrical connections to the rest of the microscope cabling with spring probes mating at the back of the PCB. The PCB sensor holder and the sensor isolated electrically preferably by placing a piece of alumina ceramic sheet in between. The sensor can also be mounted on a quartz crystal sensor or quartz crystal tuning fork or piezoelectric mechanical oscillator to run the system with the aid of AFM feedback. The sensor can also be integrated at the end of an AFM cantilever. Electrical connections from the probe (3) to PCB are achieved preferably by gold wires using ultrasonic wedge bonder or a flip chip bonder or conductive paste or conductive epoxy. The sensor holder is then screwed at the end of a piezoelectric scanner (4) to map the field over the sensor. On the other hand the mesa corner, which is used as a crude STM or AFM tip, must be in closest position to the sample (12). To satisfy both requirements, the sample (12) is tilted 1-1.5° with respect to the probe (3). There are set of screws on the sample puck to achieve this. Increasing the tilt angle more than 3° may cause the chip edges to touch the sample (12). Also, increasing the sample increases the separation of the active region and decreases the magnetic signal. On the other hand if the angle is set lower than 1°, defects or spikes left from the fabrication can touch the surface and create unwanted signals by shorting the current or voltage leads of the Hall sensor to the sample (12) bias voltage or can increase the probe-sample separation. Probe-sample separation is important in terms of both spatial resolution and field sensitivity. Spatial sensitivity is the ability to resolve the fine magnetic structures on the sample. In that sense, the smaller the Hall probe (3) size, the better resolution is obtained. Nevertheless, if the probe-sample separation is bigger than the size of the cross (13), that is the size of active Hall area, aimed structural resolution cannot be obtained. In addition to that, the field decays with the distance and quantification of it is not possible when the probe (3) is far from the sample. The main noise component of the Hall voltage signal comes from the Johnson noise which is generated by the thermal agitation of the charge carriers. The signal to noise ratio (SNR) has to be maximized for a better performance. To maximize the signal to noise ratio (SNR) the material should have low serial resistance, low carrier density and high carrier mobility in order to minimize the resistance and maximize the Hall coefficient.

Approach mechanism is used for bringing the probe (3) and the sample (12) in to close proximity of each other for a proper mapping since the magnitude of the interaction between the sensor and the sample (12) and the property aimed to be measured varies as a function of the probe-sample distance. Preferably a simple stick-slip coarse approach mechanism is incorporated in this invention. The basic principle of the motion provided by said coarse approach is based on the control of the inertia with piezoelectric ceramic element to direct the motion of a slider (10). The sample slider puck (9) is attached to the slider tube (10) by using a leaf spring (11). The slider tube (10) is glued to a slider piezo tube (14). The slider (9) is mechanically clamped to the tube (10) using a leaf spring (11), whose tightness is adjusted to hold the slider puck (9) even in vertical position by frictional force. To move the slider puck (9) a rapid electrical asymmetric voltage pulse is applied to piezo (14) over a short period of time. This voltage pulse gives a small acceleration which is not enough to overcome the static friction and the puck (9) moves together with the tube (10) attached to the piezo (14). Said small acceleration is followed by a large deceleration on the opposite direction, which is so rapid that the puck (9) overcomes the static friction and remains stationary for a short time while the tube (10) is contracted. The sliding puck (9) can move in both directions, up and down. To reverse the direction an opposite polarity pulse is applied. Step size can be varied by adjusting the magnitude of the voltage pulse. The tightness of the leaf spring (11), can change the frictional force of the slider puck (9) on the tube (10). Thus, it may not be possible to obtain exactly the same step size over a certain motion length. Also when the microscope (1) is vertical, backward and forward step sizes are different due to the mass of the slider puck (9). The sample (12) can also be moved laterally in X & Y directions using the same slider piezo (15). The sample mount which is clamped by another spring can freely move along the X & Y directions. Accelerations applied by the slider tube (10) in X and Y directions will cause the movement of the sample mount and the specimen mounted on. A capacitive encode is mounted at the back of the sample (12) positioned to measure the absolute position in XY directions.

Before scanning the sample (12) is approached by coarse approach mechanism towards the probe (3) until a set feedback parameter (tunnel current or force) is successfully maintained. The feedback control is done by lowering the sample (12) towards the sample extending the scanner piezo (4) right after the forward step of the slider (10). If the feedback signal level is not reached in the range of the scanner piezo (4), it is retracted back and another forward step is done by stick-slip motion.

Piezoelectric scanner (4) can control the precise position of the probe (3) over the surface, both vertically and laterally. Said scanner (4) is preferably in tubular form composed of four outer segments (quadrants) electrically isolated from each other end one inner electrode. They are produced from preferably artificial ferroelectric PZT ceramics. Application of voltage with right polarity to the designated electrodes results in dipole arrangement with respect to the field created. So, when a voltage is applied they change their shape; contracted or extended (elongated). The high voltage signals sent by the electronics drive the scanner (4) and the attached probe (3) over the sample (12) in a raster scan in two dimensional pattern. An image of the sample is obtained, depending on the nature of the interaction, representing the topography, magnetic properties, or any other physical, morphological or structural property.

Controller electronics (5) controls signal acquisition & amplification, XYZ piezo motor movements, feedback control, data acquisition, scanning operations. The electronics used is composed of modular cards, which are head amplifier, power supply, scan DAC, high voltage amplifier, DAC card, slider card, FPGA and A/D card, digital feedback controller card, hall probe amplifier card, phase locked loop card, spare A/D card, with different functions. Some modules are functional all the time during scanning, whereas, some of them are specific to the application.

Head amplifier is housed in a box and attached to the microscope head through the connectors. The connector is preferably a Lemo connector. The other end of the card has another connector for input/output power supply. The head amplifier has a differential input, low noise Hall amplifier with a gain of preferably 1,001. The output voltage of the Hall sensor is amplified through this fixed gain differential amplifier, which uses the classical three operational amplifiers topology. The frequency dependent gain of the amplifier depends on the operational amplifier used. The feedback signal is measured with another opamp which has low input bias current, in transimpedance mode. The feedback signal can be either tunnel current or AC piezoelectric current induced on the oscillating force sensor.

Power supply card generates all the relevant regulated voltages for the controller.

Scan DAC card generates the scan voltages used for scanning the piezo tube (4). The output range and resolutions are preferably ±10 V and 20 bits, respectively. These voltages are sent to high voltage amplifier card through the backplane. Pixelization in XY scans affects the resolution such that features smaller than the pixel size of the image cannot be resolved. Thus the voltage sent to the XY scanner is important. The relationship between the movement of the piezo (4) and the applied voltage is nonlinear. This causes the forward and reverse scan directions to behave differently and display hysteresis between the two scan directions. This anomaly can be corrected with appropriate non-linear voltage application to compensate the movement of piezo (4).

High voltage amplifier card combines and amplifies X&Y scan voltages generated by scan DAC card with the Z-voltage and generates directional preferably north, south, east and west voltages to drive the piezo (4).

In a preferred embodiment of the invention high voltage amplifier supplies the piezo drive signals for the quadrant electrodes of the tube piezo (4) as follows:

S (South)=−10×(V_{Z}+V_{Y})

N (North)=−10×(V_{Z}−V_{Y})

E (East)=−10×(V_{Z}−V_{X})

W (West)=−10×(V_{Z}+V_{X})

In the described embodiment V_{Z}, V_{X}, V_{Y} can take values within ±10V. Therefore the outputs of the high voltage amplifier card should be able to swing ═200V.

DAC card supplies (V_{Bias}), Z_{offset}, V_{coil}, I_{SET} for the controller.

Slider card is used to drive the stick-slip piezo sliders (14). Said card generates a specially optimized non-linear high voltage pulse, which is multiplexed to the relevant electrodes by relays under control. The outputs are preferably short circuit protected.

FPGA and A/D card facilitates the controller interface using a USB 2.0 high speed serial port between the personal computer and the Controller. In a preferred embodiment of the invention said card measures the relevant 8-channels of voltages with 16 bit resolution.

Digital feedback controller card achieves tunneling feedback and keeps tunnel current or force constant by adjusting the tip-sample separation. There is preferably −100 mV/nA gain current to voltage converter at the head amplifier box attached to the head. In STM mode, tunnel current input is first rectified, then passed through a logarithmic converter (to linearise the exponential I_{T} distance relation), then compared with a set current value. All the operations are done digitally after the input signal is digitized using a fast, high resolution (20 bit) ADC. The voltage output is generated using 20 or 24 bit DAC and is sent to the high voltage amplifier. The resolution in the vertical direction is primarily determined by the resolution of the vertical scanner movement. How fine the number of data points in the vertical dimension can be set is calculated by the conversion of 20 or 24 bits over the full vertical range of scanner which is ±100V.

Hall probe amplifier card further processes (amplifies, shifts & filters) the Hall voltage generated by the Hall sensor. It also supplies the DC Hall current (I_{Hall}) to drive the Hall sensor. The range of (I_{Hall}) can be jumper selected to be ±100 μA or ±1000 μA. The jumper selection is automatically detected and adjusted. The Hall current can be switched on or off. When switched off, the current lead are short-circuited to each other. The operation of the Hall sensor is not limited to DC current and in a preferred embodiment of the invention it also covers; AC Hall current, AC external Magnetic field and phase sensitive detection of the Hall voltage. There is a ×1001 gain Hall probe amplifier at the amplifier box attached to the head. Output of this amplifier should be connected to V_{H} in on the Hall probe amplifier card. Said input is further amplified, subtracted by offset value, filtered by Hall probe amplifier card, and output to the front panel. V_{H} out is used to monitor the microscope (1). There is also a voltage limiter in order to protect the Hall probe for accidental over voltages and high currents.

Spare A/D card lets the controller to digitize up to 8 channels of more input signals with 16 bit resolution at a maximum speed of 200 k samples/s. The inputs of said card are preferably differentially buffered.

High Speed USB2.0 interface facilitates high speed digital data acquisition.

While scanning the sensor, the SHPM feedback control circuit maintains the scanner to be in a proper z-position tracking the surface topography. This is done by continuously measuring the electrical error signal picked by the probe and comparing it with the set value. The feedback control changes the high voltage signals to elongate or contract the scanner in z direction until a match is obtained between the read and set values. Proper selection of feedback parameters (PID parameters) is important as it can affect the overall image quality. When the feedback gain is too high, this may cause the scanner to oscillate at the system resonant frequency. On the other hand if the gain is too small, it cannot react to the error signal changes quick enough and the topography appears to be smoother than it actually is. This can also damage the probe. It is also possible to scan while the feedback is disabled if the examined surface is extremely smooth and has no slope. Generally, a scan without feedback is faster but, the scanner has to be lifted off for some height to ensure no obstacles will be present during the scan, which decreases the sensitivity of detection.

To scan the sample, alternating voltages are applied to the outer electrodes. As the applied voltage difference induces strain (or stress) it causes the tube to bend back and forth in X&Y directions. While bending the piezo in one quadrant, high voltage is applied to opposite electrodes has the same magnitude but in opposite polarity. By this way a designated area can be scanned. In a preferred embodiment of the invention X is chosen to be the fast scan direction. While the scanner is moving along a scan line data sampling is done at equally spaced points. This spacing between the consequent data points is called the pixel size and can be adjusted. The pixel size determines the resolution of the image and the incremental change in high voltage applied to the scanner electrodes. Although a square image, with equal number of pixel sizes on both fast and slow scan directions, is taken in a preferred embodiment of the invention; in another embodiment of the invention any step and scan size within the limits of the scanner can be set.

The maximum scan size that can be achieved with a particular piezoelectric scanner depends on the length of the scanner tube, the diameter of the tube, its wall thickness and the piezoelectric coefficients of the particular piezoelectric ceramic used in the microscope. While scanning the measured signal is stored in an array whose dimensions are given by the set resolution or the step size. The elements of this matrix are used to generate false image of the scanned property.

The microscope can be run in different scan modes. One embodiment is the tracking mode in which surface texture is followed by the probe for simultaneous topographic and magnetic detection. In the tracking mode, either the tunnel current between the STM tip (the gold coated corner of the mesa at the Hall sensor chip) and the sample is measured and used to drive the feedback loop or AFM feedback where the force, force gradient or the magnitude change or frequency shift in resonance of a cantilever due to the interaction with the sample is detected. In the preferred embodiment the magnetic sensor is mounted on a quartz crystal tuning fork or quartz crystal sensor or integrated in an AFM cantilever. The force sensed can be vertical force or shear or torsional force by appropriate (vertical, shear or torsional) excitation of the force sensing sensor. The force sensor (piezoelectric, piezoresistive, strain, capacitive etc) can be excited mechanically or by electric self excitation. This mode of operation gives the highest sensitivity because of the smallest probe-sample separation is achieved. Also, rough surfaces can slightly affect the magnetic image quality since the probe will move up and down while following the texture and its local Hall sensor height will not be the same from point to point. Another embodiment is the lift-off mode, where the Hall sensor is lifted off to a certain height above the sample ensuring there is no obstacle in the scan area and the head can then be scanned extremely fast to measure the local magnetic field distribution. As the sample-probe distance is increased the resolution also decreases. However, this mode gives opportunity to scan many images in shorter time. In another embodiment microscope running mode is the real time scan mode. This mode is the same as the lift off mode except the image is shown after the scan is completed. However, only one channel can be recorded in this mode. Another embodiment is the lift-off scan mode. In this mode feedback is on and the surface topography is followed stored during the forward scan. Then the head is lifted off at certain set value and the registered line profile is followed with this given offset during backward scan.

In another embodiment of the invention the scanning hall probe microscope is used as scanning tunneling microscope (STM), atomic force microscope (AFM), magnetic force microscope (MFM) by replacing the Hall probe with appropriate sensors.

In another embodiment of the invention different approach mechanisms like, mechanical screws and capacitance detection used by Moler group, piezoelectric detection of the shear forces used together with the step motors can be used. It is also possible to move the sample laterally by using the XY slider.

The method to measure 3 component of the magnetic field vector at a nanometer resolution is a method used to measure magnetic field variation in space by using above described the scanning Hall probe microscope. By using said method any semiconducting, semi-metal, metal or conducting material suitable for a Hall effect device is applicable with a simple fabrication process. The spatial resolution is defined by the width of the Hall junction cross, thus the limitation only comes from the fabrication capability or from the material properties, such as the surface charge depletion after certain size.

The scanning procedure is explained briefly as follows:

The Hall probe (3) is connected to the end of the piezo scanner (4) by screwing the printed circuit board (PCB) that houses the Hall probe (3) on to the special end piece preferably using two M1.6 screws. Electrical connections between the sensor and the control electronics (5) are maintained by the designated paths on the PCB that are physically in contact with the wires that carries the voltage and current signals through the microscope body (2) to the control electronics (5). The sample (12) to be inspected is glued onto the sample holder (8) preferably with silver conductive paint as flat as possible and allowed to dry. Drying duration is preferably 15-30 minutes. The sample holder (8) is placed on the designated area of the sample slider puck (9) and fixed through by inserting the pins to their holes. The sample slider puck (9) is attached to the glass tube (10) by using a leaf spring (11) and preferably two special M1.6 stainless steel screws. These screws are loosened and the puck (9) is rotated so that the spring (11) faces the earth, to pull the spring (11) down due to gravity. Then the puck (9) is sled gently over the glass tube (10) carefully avoiding contact with the Hall probe (3). The slider puck (9) touches the glass tube (10) preferably by 4 contacts at the puck body (9) and spring (11) itself. If the screws are loose, the puck (9) will fall, or not move upward. The LT-SHPM is engineered such that the slider puck (9) works reliably at every temperature between mK-300K if the leaf spring (11) is fully tightened. When the 4 contacts of the puck (9) touch the glass (10), the sample slider puck (9) is rotated to have one of the alignment screw's middle point coincides with the bottom corner of the Hall probe (3). Puck (9) can be turned on the quartz tube (10) to achieve the desired orientation as long as the leaf spring (11) is loose enough. Final decision is done after the leaf spring (11) is tightened. Whole LT-SHPM insert is rotated so that the screws fixing the spring are at the top. These screws slowly tightened one turn at a time one after another until they both are fully tight. The SHPM head is positioned under the optical zoom microscope with ˜×40 magnification. All the leads of LT-SHPM are connected to the SPM Controller. SPM Control Electronics (5) is powered on and the SPM program is run. The slider (14) is driven by the stick-slip slider control card at the SPM Control Electronics. The card generates a special voltage pulse and multiplexed to the relevant electrodes. SPM control Program lets to move the slider (14) in 3 dimensions, XY & Z with the keypad or mouse control. Sample (12) is brought in to close proximity of the Hall sensor manually with the aid of the zoom microscope until the reflection of the Hall sensor on the sample (12) is seen. The sample (12) is tilted around 1-1.25° with respect to the Hall probe (3). Preferably the M1.6 screws, which fix the sample plate on sample puck, has a pitch length of preferably 0.2 mm. With the pitch circle diameter (PCD) of 20 mm and 3 mm screw head diameter for these 3 screws, one turn of the any screw will tilt the sample plate 0.76°. When the Hall sensor is reasonably far away from the sample (12) surface, three screws are adjusted to make the sample (12) as parallel as possible to the sample (12). The parallelism is checked by bringing the sample close to the Hall probe (3) for a better accuracy. The physical sides (sides without bonding wires) of the Hall probe (3) and their reflections must be parallel to each other. When the Hall sensor is parallel to the sample (12), the sample (12) is pulled away and the screw which is positioned at the same side of the Hall sensor's corner is loosened by 1¼ or 1½ turns to give the final angle. The angle should be uniform at each side of the Hall probe (3) chip. After getting quite close under the optical microscope, the slider puck (9) is moved back around 30 steps. The protective shield is put on the head very gently and fixed using the three M1.6 screws. Voltage bias to the sample is checked by short circuiting the shield and the sample holder observing a zero voltage reading on the SPM software. The temperature of the cryostat or PPMS is set to preferably 300K, as the system is flushed with Helium gas, the microscope (1) is carefully and slowly insert the microscope in. LT-SHPM is fixed to KF40 flange using a clamp. The sample space of the cryostat or PPMS is flushed with Helium couple of times to purge all the gas trapped around LT-SHPM and sample space of the cryostat or PPMS. The microscope (1) is cooled down to the desired temperature by a rate of 2-3 K/min. When the desired experiment temperature is achieved the Hall sensor is offset nulled to measure the quantitative field value over the sample. Automatic approach sequence is initiated to seek the tunnelling current after the desired current value is set. The usual set current is around 1 nA. The software and the control electronics take care of the approach sequence until the set tunnelling current value is established between the sample and the tip of the Hall sensor. Feedback control will keep the tunnelling current fixed during the entire experiment. Atomic force microscopy feedback can also be used as well as the tunnelling feedback. When the surface is in the measurement range due to the fixed tunnelling current the sample is scanned by setting the imaging parameters. Scan area, scan speed, resolution and the acquisition channels are set through the SPM control program. Then, sample (12) is scanned for simultaneous magnetic and topographic data.

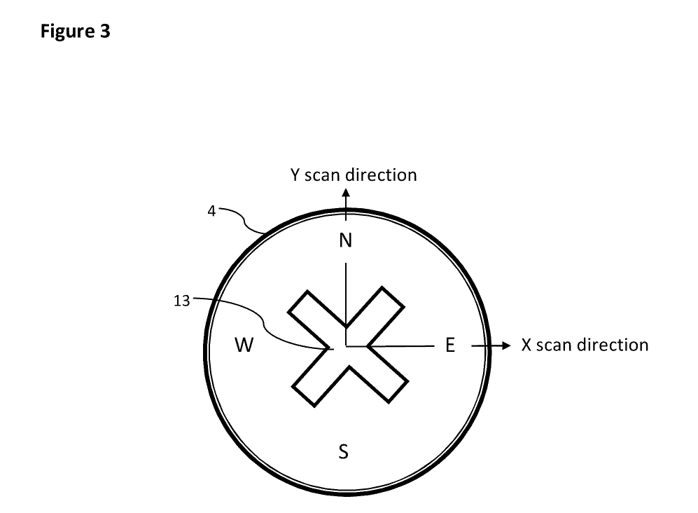

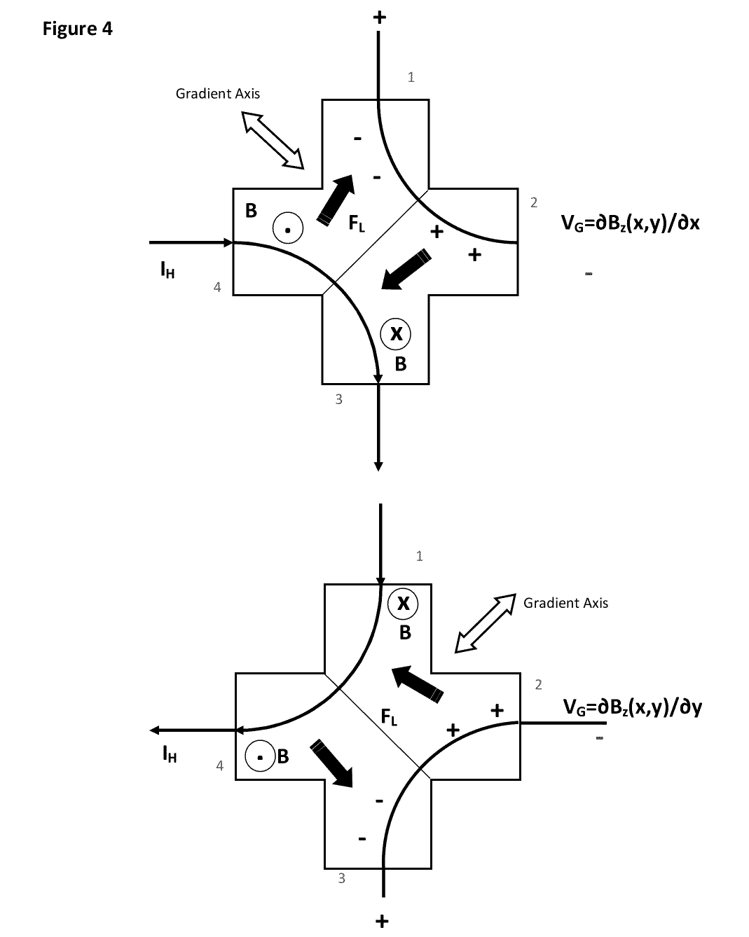

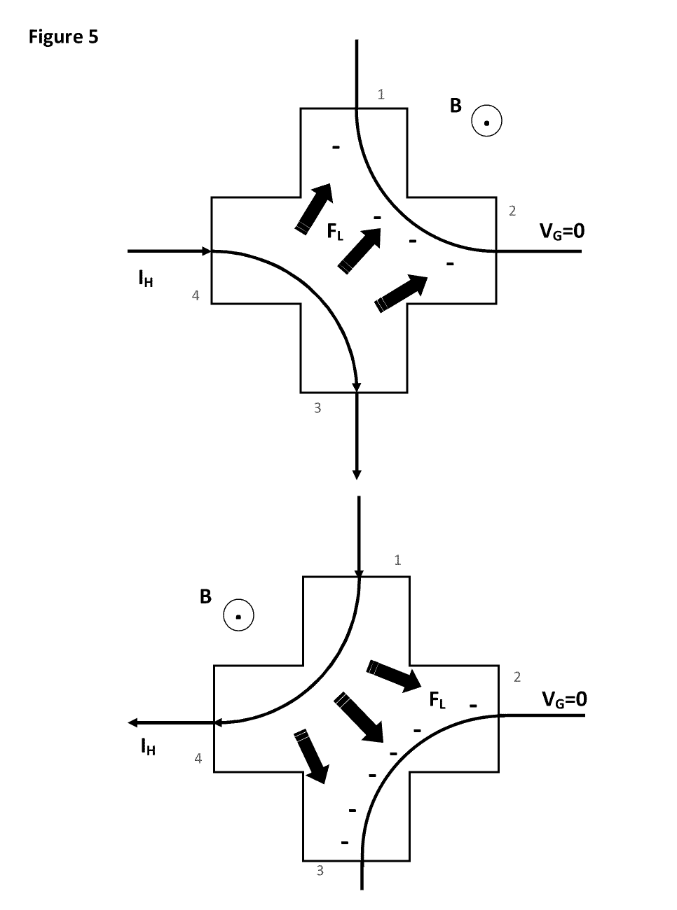

By this method; the current and voltage signals can be passed through any of four leads of the Hall cross by using low noise amplifier. The restriction of having the current and the voltage leads to be mutually perpendicular to each other is eliminated. If the current does not follow a straight path, the Hall effect can still be observed, which is called as bending resistance if there exist a spatial non uniform magnetic field (FIG. 4). In the preferred embodiment of the invention the current is passed between the adjacent leads of the hall sensor and the voltage is measured between the two other leads. When there is no external magnetic field and field gradient the developed voltage will be proportional to the resistivity and current. In the preferred embodiment of the invention this voltage is subtracted from the further measurements where the voltage is measured in presence of magnetic field and gradients. As the current flows at any particular point along the path, the magnetic force Fm is perpendicular to the direction of motion. In uniform magnetic field however, the Hall voltage (after subtraction as described above) would be equal to zero (FIG. 5). But, if the magnetic field distribution across the device is spatially non-uniform and non-symmetrical along the gradient axis, there will be a finite voltage developed at the voltage terminals (after subtraction as described above). The lateral electric field E generated to balance the magnetic force is not uniform across the device; in other words, it has a gradient along the device. As a result, the measured potential is the derivative of the perpendicular magnetic field in the active region of the Hall cross as described in FIG. 4. Depending on the current flow path the derivative about to different diagonals of the Hall cross is measured with non-perpendicular current and voltage leads with different configurations and the field gradient axis. The orientation of the sensor over the magnetic field distribution of the measured sample is important. According to this invention the Hall probe has a fixed position with respect to the quadrants of the scanner piezo. Thus, the orientation of the probe is not changing during the scan which is placed preferably by 45° with respect to the X & Y scan directions (FIG. 3). On the other hand the sample can be aligned in any desired rotational angle with respect to said Hall sensor.

As different sample orientations are scanned, different images are obtained in lateral derivative, which was actually expected as the gradient of the field changes in the space. This measurement mode clearly gives the local gradient of the B_{z}(x,y), which can be used in a number of applications like gradiometry etc.

A more important ramification is the possibility of measuring in-plane components, Bₓ(x,y) and B_{y}(x,y) of the magnetic field if B_{z}(x,y), ∂B_{z}(x,y)/∂x and ∂B_{z}(x,y)/∂y are measured across the space. Starting with the Maxwell equation derived from Ampere's law,

$$\vec{∇} \times \vec{B} = {ɛ}_{0} {μ}_{0} \vec{J} + {ɛ}_{0} {μ}_{0} \frac{\partial \vec{E}}{\partial t}$$

In a source free region of the space if the electric field is also stationary the equation simplifies to,

\vec{∇}×\vec{B}=0

which can be written, in open form, as

$$( \frac{\partial }{\partial x} \hat{i} + \frac{\partial }{\partial y} \hat{j} + \frac{\partial }{\partial z} \hat{k} ) \times ( {B}_{x} \hat{i} - {B}_{y} \hat{j} + {B}_{z} \hat{k} ) = 0$$

from which,

$$( \frac{\partial {B}_{z}}{\partial y} - \frac{\partial {B}_{y}}{\partial z} ) \hat{i} - ( \frac{\partial {B}_{z}}{\partial x} - \frac{\partial {B}_{x}}{\partial z} ) \hat{j} + ( \frac{\partial {B}_{y}}{\partial x} - \frac{\partial {B}_{x}}{\partial y} ) \hat{k} = 0$$

To satisfy the equation each vector component must individually be equal to zero.

$$( \frac{\partial {B}_{z}}{\partial y} - \frac{\partial {B}_{y}}{\partial z} ) = 0$$

$$( \frac{\partial {B}_{z}}{\partial x} - \frac{\partial {B}_{x}}{\partial z} ) = 0$$

$$( \frac{\partial {B}_{y}}{\partial x} - \frac{\partial {B}_{x}}{\partial y} ) = 0$$

The first two equations can be solved in terms of the parameters measured at the beginning of the problem. Hence it can be written that,

$$( \frac{\partial {B}_{z}}{\partial y} - \frac{\partial {B}_{y}}{\partial z} ) = 0 \\ ⇒ \frac{\partial {B}_{z}}{\partial y} = \frac{\partial {B}_{y}}{\partial z}$$

$${B}_{Y} = {\int }_{z}^{∞} \frac{\partial {B}_{z}}{\partial y} d z$$

Hence if directly measuring the ∂Bz/∂y or obtaining ∂Bz/∂y by differentiating B_{z}(x,y) along y as a function of z, then the B_{y} at this specific z can be calculated. The SHPM data should be obtained at increasing sample-sensor distances, until the signal decays to zero or below the noise levels. A similar equation can be written for Bₓ as well,

$${B}_{x} ( x , y , z ) - {\int }_{z}^{∞} \frac{\partial {B}_{z} ( x , y , {z}^{′} )}{\partial x} d {z}^{′}$$

Hence if directly measuring the ∂Bz/∂x or obtaining ∂Bz/∂x by differentiating B_{z}(x,y) along x as a function of z, then the Bₓ at this specific z can be calculated. The SHPM data should be obtained at increasing sample-sensor distances, until the signal decays to zero or below the noise levels.

As, it is not possible to integrate the equations analytically, they have to be computed numerically from the measured data.

$${\int }_{z}^{∞} f ( {z}^{′} ) d {z}^{′} ≅ h [ {\sum }_{j = 1}^{n} f ( jh ) ]$$

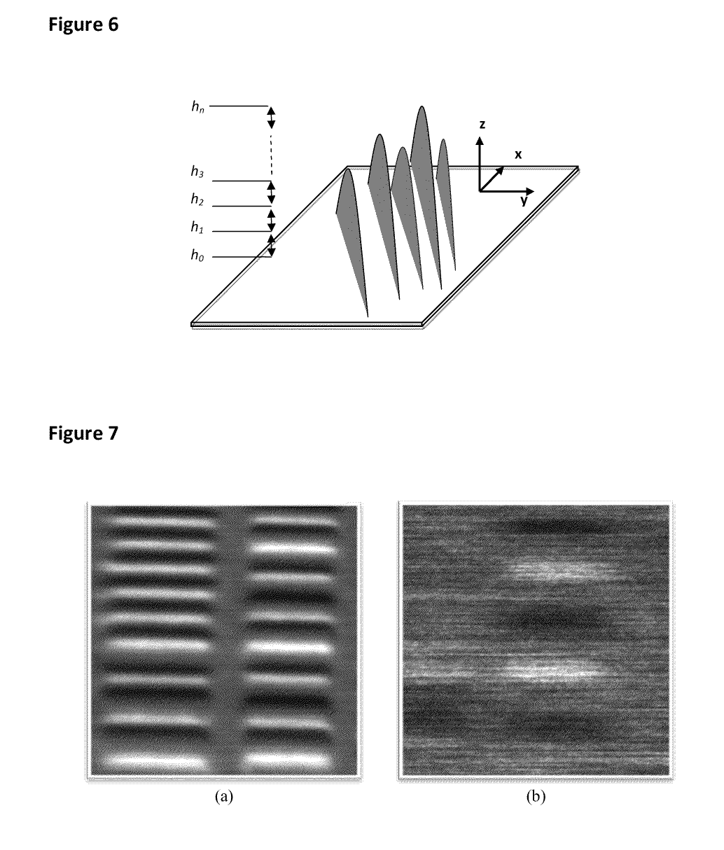

The situation can be visualized with the aid of FIG. 6. While measuring the quantitative value of the perpendicular magnetic field, B_{z}, at the closest sample-sensor position, the partial derivatives will also be measured. ∂B_{z}(x,y,z)/∂x and ∂B_{z}(x,y,z)/∂y until we do not see any contrast.

Note that having an infinite sum does not be needed as the field value f(jh) will decay after a certain value of jh that can be set as the finite upper limit n. Thus, B_{z}(x,y,z), ∂B_{z}(x,y,z)/∂x and ∂B_{z}(x,y,z)/∂y are acquired at different heights (zᵢ) until the field decays to zero, carefully recording the values. A fixed incremental separation h is used between the scans for ease of calculation.

While the sample is scanned the surface is never perfectly smooth. In addition to this, some inclination angle can unintentionally be given, while mounting the sample. For this reason, while the sample is scanned with a liftoff, this distance must be applied throughout the sample evenly. The magnetic force microscopy (MFM) techniques, where the magnetic and interaction forces have to be separated, can be applied to this case. Hence, while the forward scan is conducted using the feedback following the surface texture; the backward scan is performed following the same texture, however this time, by adding the required lift-off value at each pixels. By this procedure, the value of h is held fixed throughout the whole scan area. FIG. 7 shows the image of Hard disk with the forward scan, (a) while the probe is in closest proximity of the sample, and backward scan (b) while the probe is lifted off by 3.5 μm. The decay of the magnetic signal when the probe is lifted off by 3.5 μm away from the surface can clearly be seen and obviously this distance can be accepted as the upper limit of the integration while calculating the Bₓ and B_{y}.

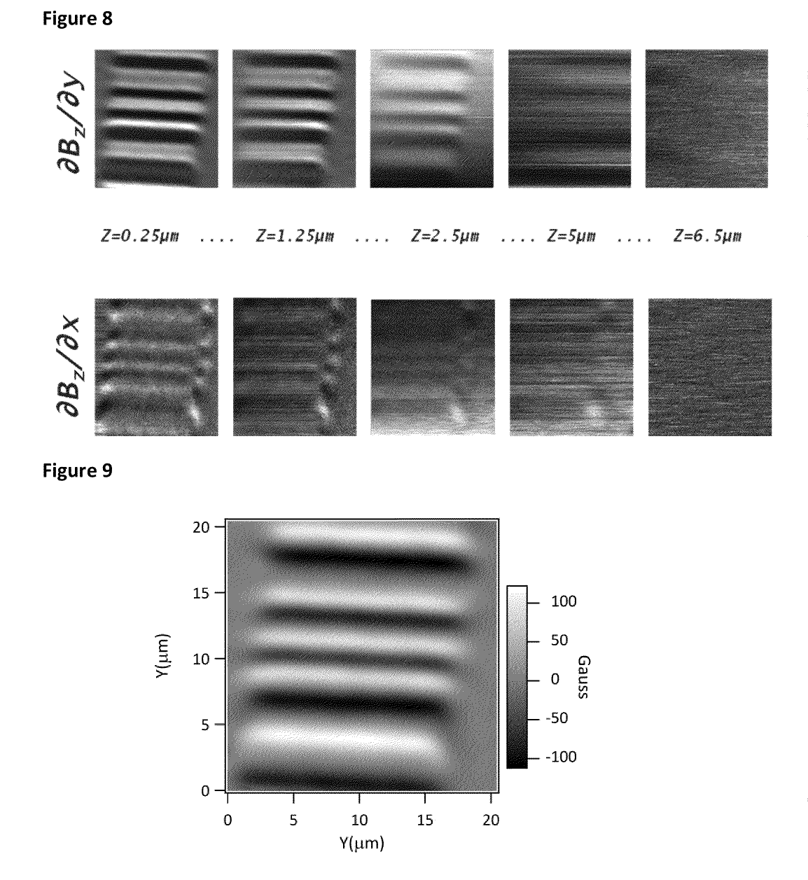

To show the principle of operation Overall 26 scans are performed using SHPM with AFM feedback surface tracking, starting from the closest proximity of the sample, with 250 nm steps, until the probe is 6.5 μm away from the sample in height. At each height level, B_{z}(x,y), ∂B_{z}(x,y)/∂ax and ∂B_{z}(x,y)/∂y were measured and imaged, as shown in FIG. 8. Also FIGS. 9-11 shows the B_{z}, B_{y} and Bₓ field of an Hard disk sample. Alternatively STM feedback tracking or other possible methods (AFM tracking etc) can be employed in SHPM for 3 Dimensional imaging of magnetic fields.

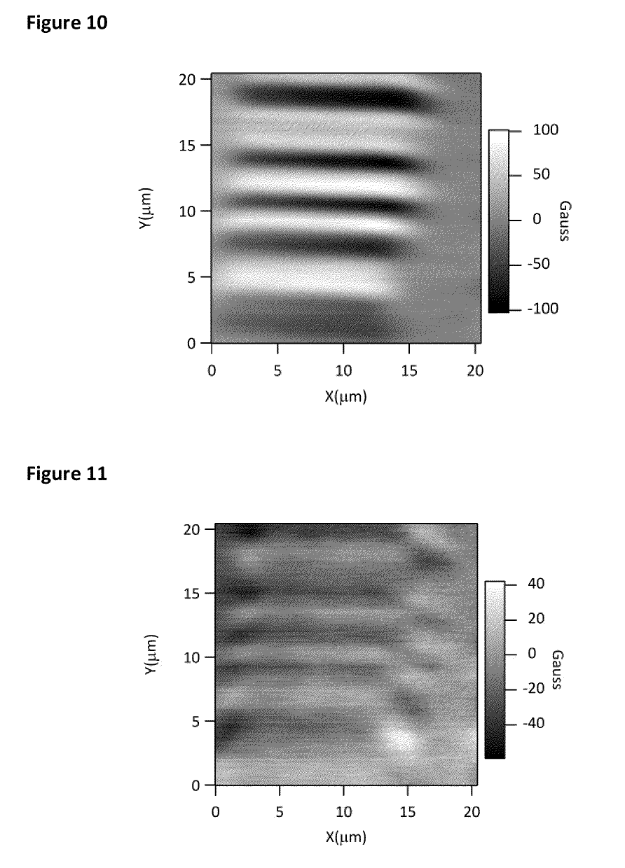

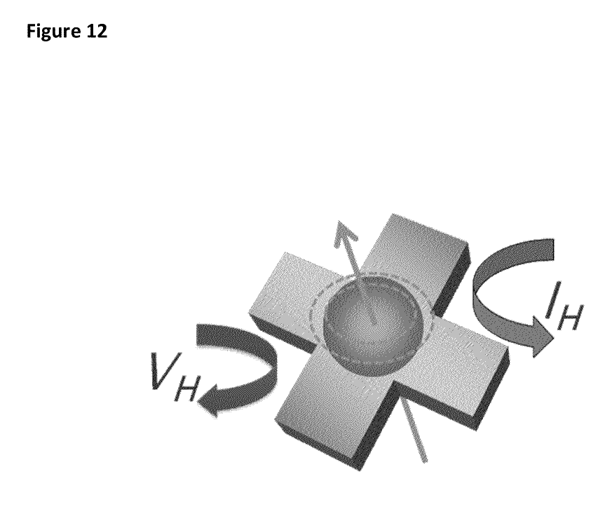

For biological or chemical detection, the Hall sensor surface can be functionalised to fix the magnetic nano and micro-beads, which are already attached to the biological entity (virus, cell, ligand, DNA fragment, DNA, dendrimer etc.) which needs to be detected. In one embodiment of the invention has at least 3 legged hall gradiometer device where two adjacent arms of the Y-junction is used to drive the current and the two other adjacent arms (one arm is used together) as shown in FIG. 10. In preferred embodiment external magnetic field is swept and the existence of magnetic bead is detected as a signal at the voltage leads of the gradiometer. In the preferred embodiment these leads can be commutated to increase the sensitivity and reduce the noise.

What is claimed is:

1. A method to measure 3 component of the magnetic field vector at nanometer resolution using scanning hall probe microscopy comprising the steps of;
connecting of Hall probe to the end of the piezo scanner,
gluing of the sample to the sample holder,
positioning of the SHPM head under the optical microscope with ˜×40 magnification,
moving back of the slider puck around ˜30 steps OR moving the sensor or sample back by sufficient amount using motors, piezo or other positioner such that signal decays to negligible levels
setting the temperature of cryostat or to desired temperature,
offset nulling of the Hall sensor in gradiometer or normal conditions,
setting of the scan area, speed, resolution and the acquisition channels through SPM control program.

2. The method of claim 1 wherein:
Magnetic field gradients (∂B_{z}(x,y)/∂x and ∂B_{z}(x,y)/∂y) are measured in two directions.

3. The method of claim 1 wherein:
∂B_{z}(x,y,z)/∂x and ∂B_{z}(x,y,z)/∂y) in addition to B_{z}(x,y,z) are measured in the volume above the specimen.

4. The method of claim 1 wherein:
Numerically calculated ∂B_{z}(x,y,z)/∂x and ∂B_{z}(x,y,z)/∂y) from volume data of B_{z}(x,y,z) from directional derivatives along x&y directions.

5. The method of claim 1 wherein:
Integrating the ∂B_{z}(x,y,z)/∂x and ∂B_{z}(x,y,z)/∂y) values either measured or calculated from B_{z}(x,y,z) volume data as a function of z-distance to measure Bₓ(x,y) B_{y}(x,y), while the B_{z}(x,y) would already have been measured.

6. A scanning hall probe microscopy is characterized by at least 3-legged planar square/cross Hall probe.

7. A Hall gradiometer characterized by at least 3-legs/junctions for detection of magnetic nanoparticles or microparticles.
